(19) United States
(12) Patent Application Publication
(10) Pub. No.: US 2026/0030993 A1
(43) Pub. Date: Jan. 29, 2026

(54) AN EDUCATIONAL DEVICE AND A METHOD OF LEARNING TO WRITE WITH THE USE OF THIS EDUCATIONAL DEVICE

(71) Applicant: PIOTR OSES, Poznan (PL)

(72) Inventor: PIOTR OSES, Poznan (PL)

(73) Assignee: PIOTR OSES, Poznan (PL)

(21) Appl. No.: 18/997,090

(22) PCT Filed: Jun. 12, 2023
(86) PCT No.: PCT/PL2023/000030

§ 371 Date: Jan. 19, 2025

(30) Foreign Application Priority Data
Jul. 19, 2022 (PL) P.441781

(51) Int. Cl. G09B 5/06; G06F 3/02

(52) U.S. Cl. CPC G09B 5/06; G06F 3/0219

(57) ABSTRACT

An educational device consisting of a master device and at least one slave device, each having a plastic housing with keys, inside which there is an electrically powered PCB with a microcontroller equipped with software. A method for teaching writing using the teaching device having a master device and each slave device with an SD card with recorded audio data that display a program containing a text editor, an animation window and a module for handling the master device and each slave device, on which the user of the master device runs a task for each user of the slave device, after which the master device communicates by radio with each slave device on which the LEDs of its keys turn on in accordance with the implementation of this task.

The subject of the invention is an educational device and an educational device-assisted writing teaching method, which are used to teach writing, as well as reading or pronouncing letters and words, especially by small children, including in foreign languages, and which are used especially in kindergartens, public schools, private schools and other training centres as well as for home use.

Known from Chinese Utility Model No. CN204332126U, the english word learning device comprising of a board with a remote control input unit with a line drawing device and an eraser, the board is placed on a lift cart and connected to another word display board with hinges. The word display board includes an LED screen, an infrared signal receiver and an infrared signal processing electronic board. The remote-control input unit has an alphabet input keyboard, a start button, an infrared signal transmitter and a remote-control electronic board. While teaching, the teacher can enter words from anywhere in the classroom to facilitate interaction with students. The device can also be used to memorise words. The teacher then writes selected words on the board in their own language, and the students enter the English words through a remotely controlled input unit.

Also known from the Chinese Patent Application No. CN112071163 A is a method for teaching music theory and an auxiliary device for this method, which consists of a screen part, a keyboard and a student terminal. The on-screen portion includes a display, and the keyboard has beat time setting keys, note keys, beat keys, and function keys. The student terminal, on the other hand, has a separate housing with seven note keys (equipped with a lamp panel, an electronic clock and substitute sheet a spring), an electric control board and a power supply device. Said auxiliary device and the electrical control board of the terminal are connected to the host computer via Bluetooth or a wireless network. The music theory teaching method consists of the following steps: A: The teacher inputs a part of the music notation through the keyboard, which is displayed synchronously on the on-screen part display, where the notation defines the number of notes, the time value of the note and the time of each measure, and after the notation is completed, the loudspeaker plays the melody according to this notation; B: Students press the note button on the student terminal according to the above notation, where when the note button is pressed correctly, a colour light on the note button lights up, and when the button is pressed incorrectly, another colour light lights up on the button; C: At the same time, when the order of pressing the note buttons on the student terminal and the note values are correct, the corresponding device lights up one colour indicator light, and if the button is pressed incorrectly, it lights up another colour indicator light; D. The teacher finds out which student pressed the wrong button by the colour of the indicator light on the corresponding device, and the sequence of the student's note button press and its duration value can be shown on the display, making it easier to guide and correct students.

Also known from the Chinese Patent Application No. CN106155345A is an interactive calling and answering system and a keyboard-type calling and answering device, as well as their use. The calling-receiving device is a keyboard, which consists of keys, a printed circuit board (PCB) with a microcontroller placed inside the casing, with a symbol associated with the calling and answering activity placed on the cap of each key, and a light diode placed under this cap. The Interactive Calling and Answering System is equipped with a remote computer and calling and answering device that is connected to the system by a single wire and can informally communicate with it using the remote display and remote data entry functions. An interactive calling and receiving system and a keyboard-type calling and receiving device can communicate and communicate common requirements, reactions, attitudes and conditions in the activities of their users, which can improve the efficiency of these activities. The invention finds application in teaching.

Also known from Chinese Utility Model No. CN203444575U is a touch control consumer machine comprising a housing, a main processor control unit, a sub processor control unit, an RFID card reading and induction module, an external communication interface, a clock module and a power supply module. This machine is also equipped with a main touch keypad, main touch electrical system, main keypad LED indicator light, sub touch keypad, touch secondary electrical system and sub keypad LED indicator light. The sub touch keyboard and the main touch keyboard operate synchronously, and the button press response may be accelerated so as to avoid that the buttons on the main touch keyboard and the sub touch keyboard are pressed at the same time. The machine can be widely used in enterprise restaurants, school restaurants, gymnasiums, reading rooms, grocery stores, self-service kiosks and consumption places using RFID cards.

The purpose of the present invention is to develop a new, hitherto unknown, simple design of an educational device that significantly speeds up the process of learning to write, read and pronounce letters and words, also in a foreign language, especially by small children (including infants). A further purpose of the invention is the possibility of partial automation of the learning process and increasing the number of students who can be effectively taught (supervised) by one teacher at the same time, learn also partially independently, in the absence of the leading teacher, i.e. by playing in interaction with the device equipped with and supplemented and appropriately developed program. The object of the invention is to provide a method of teaching writing using an educational device that will increase the effectiveness of teachers and the students' progress.

The main feature of the construction of the device is the creation of an innovative teaching method consisting in highlighting individual letter keys to be pressed by the student, while influencing the student through syllabic dictations, dictations combining letters into words, as well as repeatedly repeated sounds of letters at the time of highlighting and pressing letter keys.

The advantage of the educational device is the use of natural human cognitive predispositions in the early period of growth and development and enabling the learning of letters, and thus learning to read and write in a completely new, simple and accessible way for children aged two to five. In addition, the device, through its mode of operation, gives a new opportunity to have a beneficial effect on learning to speak and as well, as in a general development scope.

The educational device consists of a master device and one or more slave devices, each of which has a plastic housing with keys inside which there is an electrically powered PCB with a microcontroller equipped with software, characterized in that the PCB of each slave and master device has inseparably connected to it and inside the housing: power supply stabilizer, two working sockets connected by an electric cable, two connected by an electric cable power sockets, a socket for a cable plug for programming the microcontroller, a socket for a cable plug for diagnosing electronics, socket for an SD card electrically connected to a loudspeaker, which is inseparably connected to a PCB, a socket with a radio communication module with an antenna embedded in it, whereby:
the microcontroller is electrically connected to the ground and to the power stabilizer, which together with the second working port and the second power port are electrically connected to the power source and ground;
sockets: for the plug of the cable for programming the microcontroller, for the SD card and for the radio communication module are electrically connected to the microcontroller, the power supply stabilizer and to the ground;
the socket for the plug of the cable for diagnosing electronics is electrically connected to the microcontroller and the ground;
the first power socket is electrically connected to the ground and together with the first working socket, it is electrically connected to the key buttons, the keys of the slave device being equipped with LEDs.

It is preferred that the keys form a working area and a functional area, where the working area consists of working keys arranged in rows forming rows and columns, each of which has one button, and the functional area consists of one central function key having four buttons located between the two extreme function keys, each of which has two buttons.

It is advantageous when the key is made of a plastic flat base with a through hole made in its central part, the upper edges of which are inseparably connected with the lower edges of the resilient membrane, the upper edges of which are inseparably connected with the lower edges of the plastic, semi-transparent, cuboid element with a blind recess made in a central part of its lower surface forming an inverted “U” profile, around which there is a graphite annular path with a width of “a”, and also when this button is mounted on a PCB with two concentric and situated over the ring path of the element copper annular paths spaced apart by a distance “b” less than the width “a” of the annular path of the component, wherein the first annular path is connected in series by a copper path to the first rectifying diode contact and the second annular path is electrically connected to the first working socket using its copper path.

It is advantageous when on the cuboid element of the button of each working key there is a plastic overlay, on the upper surface of which there is a transparent symbol of the corresponding operating sign of the key, as well, on the elements of both buttons of each extreme function key there is a plastic overlay on the upper surface of which there is a transparent symbol of the corresponding key function sign, and on the elements of all four buttons of the middle function key there is a plastic overlay, on the upper surface of which there is a transparent symbol of the corresponding key function sign.

It is advantageous when the button of each key of the subordinate device is mounted on a luminous LED diode inseparably connected with its four contacts to the PCB so that the upper part of the LED diode is embedded in the lower recess of the cuboidal element of the button, and the contacts of this LED diode are electrically connected to the four copper paths made on the surface of the PCB.

It is advantageous when the first contact path of the button LED of each slave device working key is connected in series with the first contact of the resistor R1, and the second path and the third path of the second and third contacts of this LED are connected in parallel with the capacitor C1, wherein the second path is also electrically connected to the first power receptacle, and the third path is also connected in series with ground, and the fourth path of the fourth LED contact of each working key located in one row of the working area is connected in series with the second contact of the resistor R1 of the adjacent operational key 4, thus the fourth path of each working key of the last column of the working area is the NC path.

It is preferential that the first path of the first contact of the first button LED of each extreme function key of the slave device is connected in series with the first contact of the resistor R1 and with the first path of the first contact of the second button LED, then the second path and the third path of the second and third contacts of the first button LED are connected in parallel with the capacitor C1, wherein the second path is also electrically connected to the first power socket, and the third path is also connected in series with the ground, then the fourth path of the first button of the extreme function key is the NC path, and then of the second button is connected in series with the second contact of the resistor R1 of the first button of the middle function key, and the paths of both buttons of the second outermost function key are NC paths, and further, the paths of the first annular paths of both buttons of each outermost function key of the slave device and the master device are connected in series with each other.

It is preferential that the first path of the first contact of the LED of the first button of the middle function key of the slave device is connected in series with the first contact of the resistor R1 and with the first path of the second, third and fourth buttons, and the second and third path of the second and third contacts of this LED are connected in parallel with capacitor C1, whereby the second path is also electrically connected to the first power receptacle J2, and the third path is also connected in series with ground, as well the fourth path of the fourth contact of the first, second and third buttons of the middle function key is the NC path and of the fourth button is connected in series with the second contact of the resistor R1 of the first button of the second outermost function key, and further, the paths of the annular paths of all four buttons of the middle function key of the slave device and the master device are connected in series with each other.

It is advantageous when the first working socket has twenty pins J 1a-J It connected to the paths J 1a′-J It′ made on the PCB, and the first power socket has two pins J2a and J2b connected to the paths J2a′ and J2b′ made on the PCB, while the first pin J2a and the path J2a′ of the first power socket carry power, and the second pin J2b of this socket is connected via path J2b′ to the ground, and both paths J2a′, J2b′ of this power socket are connected in parallel with the capacitor C2.

It is advantageous when the pins J 1a-J It of the first working socket are connected via their copper paths J 1a′-J It′ with the keys so that:
the first four pins J 1a-J1d of the first working socket are connected in series by J 1a′-J Id′ paths with the second contact of the resistor R1 of each working key located in the first column of the working area,
the fifth pin J 1e of the first working socket is connected in series with the path J 1e′ to the second contact of the resistor R1 of the first button of the first extreme function key,
four consecutive pins J If-J 1i of the first working socket are connected in series by J If-J 1i′ paths to the second contact of the rectifying diode of each working key located in one row of the working area,
the next pin J Ij of the first working socket is connected in series by the path J Ij′to the second contact of the rectifying diode of each function key,
the next ten pins J Ik-J It of the first working socket are connected in series by J Ik′-J It′ paths with the copper path of the second ring path of each working key of each of the working area columns, and additionally the sixteenth pin J Ip of this socket is connected in series by J Ip′ path with the copper paths of the second ring paths of both buttons of the first extreme function key, the seventeenth pin J1q of this socket is connected in series by the path J1q′ to the copper paths of the second ring paths of all the buttons of the middle function key, and the eighteenth pin J Ir of this socket is connected in series by the path J 1r′ with the copper paths of the second ring paths of both buttons of the second extreme function key.

It is advantageous when the second working socket has twenty pins J3a-J3t connected to the paths J3a′-J3t′ made on the PCB, the second power socket J4 has two pins J4a and J4b connected to the paths J4a′ and J4b′ made on the PCB, while where the first pin J4a of this socket is connected to the 5 V power source via the path J4a′, and its second pin J4b is connected via the path J4b′ to the ground, the socket for the plug of the microcontroller programming cable has six pins J6a-J6f connected to the paths J6a′-J6f made on the PCB, the socket for the plug of the cable for diagnosing electronics has three pins J7a-J7c connected to the paths J7a′-J7c′ made on the PCB, the socket for the SD card has sixteen pins J8a-J8p connected to the made on the PCB paths J8a′-J8p′, the socket with the radio communication module embedded in it has fourteen pins J1Oa-J 1On connected to the paths J 10a′-J 10n′ made on the PCB, the power supply stabilizer has three pins U2a-U2c connected with the made on the PCB paths U2a′-U2c′, and the microcontroller has:
eight pins PAO, PC0-PC3, PC13-PC15 constituting the NC pins,
pin PA 15 connected to the LEDO path,
three PC10-PC12 pins connected to LED1-LED3 paths,
PD2 pin connected to LED4 path,
PC5 pin connected to KBRO path,
three pins PBO-PB2 connected to paths KBR1-KBR3,
five PB11-PB15 pins connected to KBC0-KBC4 paths,
pin PA8 connected to KBC5 path,
four PC6-PC9 pins connected to KBC6-KBC9 paths,
PA11 in connected to D− path,
PA12 pin connected to D+ path,
PB4 pin connected to ENUM path,
PA 14 pin connected to the TCK path,
PA13 pin connected to the TMS path,
NRST pin connected to RST path,
PB3 pin connected to SWO path,
PA9 pin connected to RX2 path,
pin PA 10 connected to the TX2 path,
pin PAI connected to the BUSY path,
pin PA2 connected to the RX path,
pin PA3 connected to the TX path,
pin PB5 connected to the TXE path,
PB6 pin connected to PWR path,
PB8 pin connected to the CD path,
PB9 pin connected to DR path,
PA7 pin connected to the MOSI path,
pin PA4 connected to SS path,
pin PB7 connected to the CE path,
PC4 pin connected to the AM path,
PA6 pin connected to the MISO path,
pin PA5 connected to the SCK path,
VSSA pin connected to VS SA′ path,
four VSS 1-VSS4 pins connected to VSS 1′-VSS4′ paths,
VDDA pin connected to VDDA′ path,
VBAT pin connected to VBAT′ path,
four VDD1-VDD4 pins connected to VDD1′-VDD4′ paths,
PDO pin connected to PDO′ path,
PD1 pin connected to PD1′ path,

where paths LED0-LED4, KBR0-KBR3, KBC0-KBC9, D−, D+, ENUM, TCK, TMS, RST, SWO, RX2, TX2, BUSY, RX, TX, TXE, PWR, CD, DR, MOSI, SS, CE, AM, MISO, SCK, VSSA′, VSST-VSS4′, VDDA′, VBAT′, VDD1′-VDD4′, PDO′, PD1′ are made on the PCB.

It is advantageous when the first pin U2a of the power supply stabilizer is connected in series by the path U2a′ with one of its electrical circuits with the first capacitor C3 and ground, the second electrical circuit with the second capacitor C4 and ground Z, and the third electrical circuit with the 5V input power source, the second pin U2b of the power supply stabilizer is connected in series by the path U2b′ with ground, and the third pin U2c of the power stabilizer is connected in series by path U2c′ one of its electrical circuits with the third capacitor C3 and ground, its second electrical circuit with the fourth capacitor C4 and ground, and the third electrical circuit of this path is a 3.3 V power source.

It is advantageous when each of the pins J3a-J3e of the second working socket is connected in series by means of the path J3a′-J3c′ its one circuit with the resistor R2 and with the power source with a voltage of 5 V, its second circuit with the drain of the MOSFET transistor, whose gate is connected is in series with the U2c′ path of the U2c pin of the power stabilizer, and the source of this transistor is connected to the LED0-LED4 path of the PA15, PC10-PC12, PD2 pin of the microcontroller, the gate and transistor source are also connected in parallel with the resistor R3, each pin J3f-J3j of the second working socket is connected by the J3f-J3j ‘path to the KBR0-KBR4 path of the PC5, PB0-PB2 pins of the microcontroller, and each J3k-J3t pin of the second working socket is connected by the J3k’-J3f path of its first circuit with path KBC0-KBC9 of pins PB 11-PB 15, PA8, PC6-PC9 of the microcontroller, and by its second circuit with the first contact of the resistor R4, each of which is connected by its second contact with the ground.

It is advantageous when the first pin Joa of the socket for the plug of the microcontroller programming cable is connected in series by the path J6a′ with the path U2c′ of the U2c pin of the power stabilizer, the second pin J6b of this socket is connected in series by the path J6b′ with the path TCK of the microcontroller's PA14 pin, the third pin J6c of this socket is connected in series by the path J6c′ with ground, the fourth pin J6d of this socket is connected in series by the path J6d′ with the TMS path of the microcontroller's PA I 3 pin, the fifth pin J6e of this socket is connected in series by the path J6e′ with the RST path of the NRST pin of the microcontroller, the sixth pin J6f of this socket is connected in series with the J6f path with the SWO path of the PB3 pin of the microcontroller.

It is advantageous when the first pin J7a of the J7 socket for the plug of the cable for diagnosing electronics is connected in series by the path J7a′ with the path TX2 of the microcontroller's PA 10 pin, the second pin J7b of this socket is connected in series by the path J7b′ with the path RX2 of the microcontroller's PA9 pin, the third pin J7c of this socket is connected in series by path J7c′ to the ground.

It is advantageous when the pins J8b-J8f, J8h and J8l of the SD card socket are NC pins, the J8a pin of this socket is connected in series by the J8a′ path with the BUSY path of the microcontroller's PAI pin, the J8g and J8o pins of this socket are connected in series by J8g′ and J8o′ paths with ground Z, the J8i pin of this socket is connected in series by the path J8i′ with the U2c′ path of the U2c pin of the power stabilizer, the J8j pin of this socket is connected in series by the path J8j′ with the RX path of the microcontroller's PA2 pin, the J8k pin of this socket is connected in series by the path J8k′ with the TX path of the microcontroller's PA3 pin, and the J8n and J8p pins of this socket are connected in series by the path J8n′ and J8p′ with the loudspeaker.

It is advantageous when the J1Oj pin of the socket of the radio communication module embedded in it is the NC pin, the J 10a pin of this socket is connected in series by the J 10a′ path with the TXE path of the PB4 pin of the microcontroller, the J 10b pin of this socket is connected in series by the J 10b′ path with the PWR path of the PB6 pin microcontroller, the J 10c pin of this socket is connected in series by the J1Oe′ path with the CD path of the PB8 pin of the microcontroller, the J 1Od pin of this socket is connected in series by the J1Od′ path with the DR path of the PB9 pin of the microcontroller, the J1Oe pin of this socket is connected in series by the J1Oe′ path with the MOSI path of the PA7 pin of the microcontroller, pin JI Of of this socket is connected in series by path JI Of with SS path of pin PA4 of the microcontroller, the pins J 10g and JI On of this socket are connected in series by paths JI Og′ and 1Ori with the ground, pin J1Oi of this socket is connected in series by the path J1Oi′ to the CE path of the PB7 pin of the microcontroller, J 10k pin of this socket is connected in series by the J 10k′ path with the AM path of the microcontroller's PB8 pin, J10l pin of this socket is connected in series by the J10l′ path to the MISO path of the microcontroller's PA6 pin, and the J1Om pin of this socket is connected in series by the J 10m′ path to the SCK path of the microcontroller's PA5 pin.

It is advantageous when the VSSA, BOOTO, VSS1-VSS4 pins of the microcontroller are connected to the ground via VSSA′, BOOTO′, VSST-VSS4′ paths, and the VDDA pin of the microcontroller is connected in series by the VDDA′ path by its first electrical circuit with the capacitor C5, and then with the ground, by second electrical circuit with another capacitor C6, then with ground, third circuit with coil L, and then with the path U 1 v′, pin VBAT of microcontroller U1 is connected in series by path VBAT′ with path U1v′, each pin VDD1-VDD4 of microcontroller is connected in series by the VDDT-VDD4′ paths, its one electrical circuit with the next capacitor C7, and then with ground, and then its second electrical circuit with the U 1v′ path, where the U 1v′ path is made on the PCB and connects to the U2c′ path of the U2c pin of the stabilizer and to the next capacitor C8, and also with the VDDA′, VBAT′, VDDT-VDD4′ paths of the VDDA, VBAT, VDD1-VDD4 pins of the microcontroller, as well, each pin PDO, PD1 of the microcontroller is connected in series by the path PDO′, PD1′ to another capacitor C9, and then to the ground, and moreover, the paths PDO′, PD1′ are connected in parallel with the quartz resonator X.

It is advantageous when the PCB is inseparably connected to the next socket for the plug of the cable to the external amplifier, which has two pins J9a and J9b connected to the paths J9a′ and J9b′ made on the PCB, wherein the first pin J9a of this socket is connected in series by the path J9a′ with the path J8m′ of the J8m pin of the SD card socket, and its second pin J9b is connected in series by the path J9b′ with the ground.

It is advantageous when the PCB is inseparably connected to another socket for the plug of the mini-USB cable, which has six pins J5a-J5f connected to the J5a′-J5f paths made on the PCB, wherein the J5b pin of this socket is connected in series by the J5b′ path with the resistor R5 and with the D− path of the microcontroller's PA11 pin, the J5c pin of this socket is connected in series by the J5c′ path by one of its electrical circuit with the resistor R5 and the D+ path of the microcontroller's PA12 pin, and the other electrical circuit in series with the next resistor R6, which is connected to copper path T2e′ of the emitter of the npn type transistor, the collector of which is connected to the path U2c′ of the U2c pin of the power stabilizer, and the base is connected in series by the copper path T2b′ by its first electric circuit with the resistor R7 and with ground, wherein the paths T2c′ and T2b′ are made on the PCB, and by the second electrical circuit with the another resistor R8 and with the ENUM path of the PB4 pin of the microcontroller, and by the third circuit with the next resistor R9 and with the J5a′ path of the J5a pin of this socket, while the J5d pin of this socket is connected in series by the path J5d′ with another resistor RIO and the ground Z, and pins Je and J5f of this socket are connected in series to each other by paths J5c′ and J5f and then with the ground.

It is advantageous when the 5 V power source is the J5a′ path of the J5a pin of the socket for the plug of the mini-USB cable, a battery or an accumulator.

It is advantageous when the socket for the plug of the cable for diagnosing electronics is equipped with a module for wireless communication.

It is advantageous when the resistance of the resistor R1 is 75Ω, the resistor R2 is 4.7 kΩ, the resistors R3 and R4 are 3.3 kΩ, the resistor R5 is 22Ω, the resistor R6 is 1.5 kΩ, the resistor R7 is 36 kΩ, the resistor R8 is 100Ω, the resistor R9 is 10 kΩ and RIO is 1OOkΩ, capacitance of capacitors C1, C3, C5 and C7 are 100 nF, C2 is 220 pF, C4 is 10 nF, C6 is 1 μF, C8 is 4.7 μF and C9 is 30 pF, the inductance of the coil L is 10 pH, and the frequency of the quartz resonator X is 8 MHz.

The method of teaching writing using the educational device according to the invention consists in equipping the master device and each slave device with an SD card with recorded audio data, connecting each slave device and the master device to a power supply and connecting them to a mains-powered computer equipped with a screen characterized by in that the screen displays a program including a text editor, an animation window, and a module for handling the master device and each slave device, where a user of the master device launches a task for each user of the slave device, and then the master device radio communicates with each slave device on which the LEDs of its keys turn on according to the execution of this task, and then in case the slave device's user:
I. presses a non-lit slave key, the slave generates a sound from its loudspeaker to indicate an error has been made, and when
II. [the user] presses the flashing key of the slave device, the symbol corresponding to this key appears on the screen in the text editor, and the slave device generates a sound from its loudspeaker corresponding to this key,
III. and when the user presses all the keys of the slave device required for a given task, animations and graphics are displayed on the screen in the animation window, signalling the correct execution of the task, and then the user of the master device selects the next task on the screen in the handling module.

It is advantageous when the connection of each slave device and master device to the computer is made by wire using mini-USB cables, each first plug of which is located in the socket of the computer, and each second plug in the socket for the plug of this cable of each slave device and master device.

It is advantageous when the connection of each slave device and the master device with the computer is carried out wirelessly by means of a wireless communication module embedded in the cable plug socket for diagnosing the electronics of each slave device and the master device.

It is advantageous when during the radio communication of the devices, the user of the master device presses the keys, and the LEDs of the slave device that turn on correspond to the pressed keys of the master device and remain on until these keys are pressed.

It is advantageous when, during the task solving, the user of the master device utters a phrase corresponding to the task selected by him several times, and when he presses a key of the master device, he utters the letter corresponding to this key.

It is advantageous when during the radio communication of devices, the microcontroller of the master device sends appropriate electrical signals at a rate set in its subprogram and for a given time to the radio communication module of this device, and the LEDs of the slave device that turn on correspond to these electrical signals and are turned off until sending these electrical signals.

It is advantageous when during the solution of the task the master device generates sounds in the loudspeaker corresponding to the phrase constituting the solution to the given task, and then, simultaneously with electrical signals sent by the microcontroller of the master device, sounds corresponding to the illuminated keys.

It is preferable that the sockets for the plug of the cable to the external amplifier of each slave device and the master device are connected via a cable to the external amplifier.

It is preferable in the aspect of housing and spatial location of the entire device, which is of great importance in terms of methodology and didactics reasons, i.e. the psychological impact on the learner and the effects of his achievements through, among others, expanding the impact stimuli-by the automated version of the device, the way of using the master device and its location in the form of a keyboard with a loudspeaker dictating texts in place of the teacher.

Similarly, it is also beneficial for methodological and didactic reasons, i.e. the impact on the student and his development through the multiplicity of effects, the arrangement of the screen and loudspeaker for video animation in a way that is externally separated from the master keyboard, i.e. located separately, at a distance from this keyboard.

The use of a wireless communication module in the device and batteries or accumulators as its power source allows you to eliminate wires, which has a positive effect on cooperation with small children.

The term “NC path” used in the content of the patent description and patent claims (from English “not connected”, which in Polish means “unconnected”) should be treated as a printed electrical path not connected to anything (functional or structural) in any way, and the term “NC pin” analogously—as an electrical pin not connected to anything, while “connection to the path” should be understood as a connection by soldering or other type of permanent connection, while the term “electrical connection” should be understood as a connection enabling the flow of current and is implemented by electrically conductive elements such as wires or copper traces printed on the PCB.

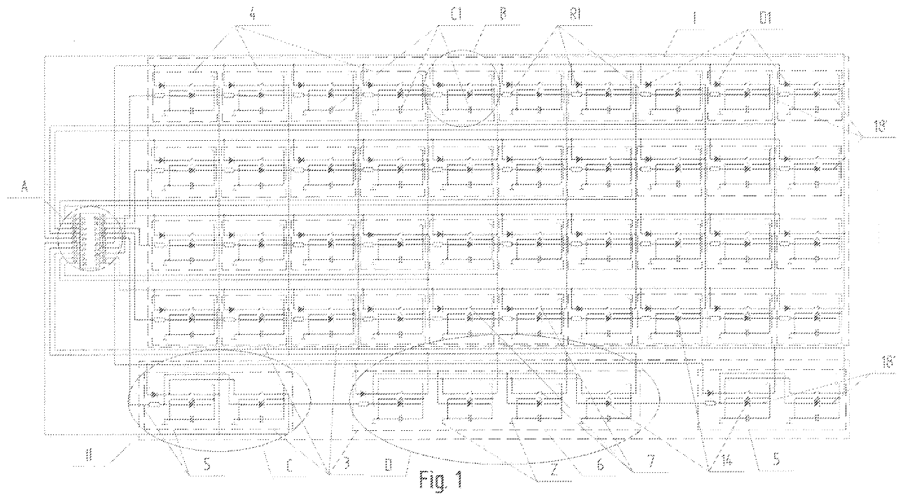

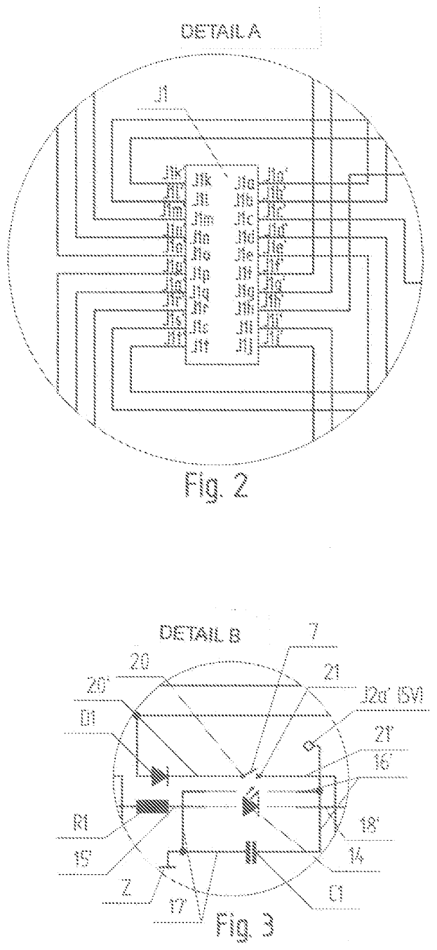

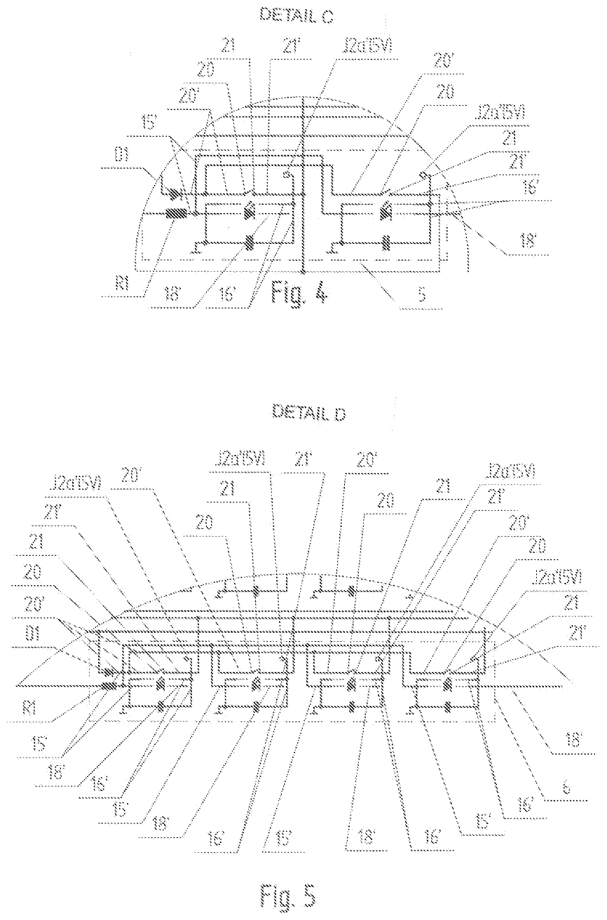

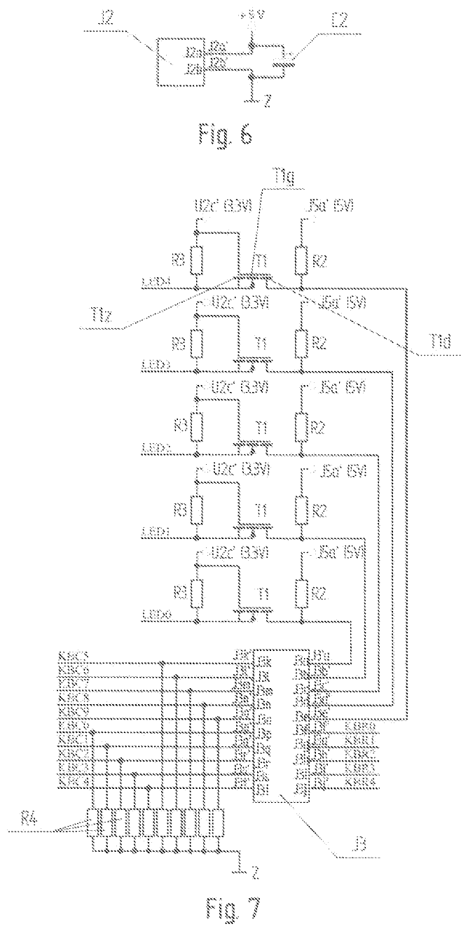

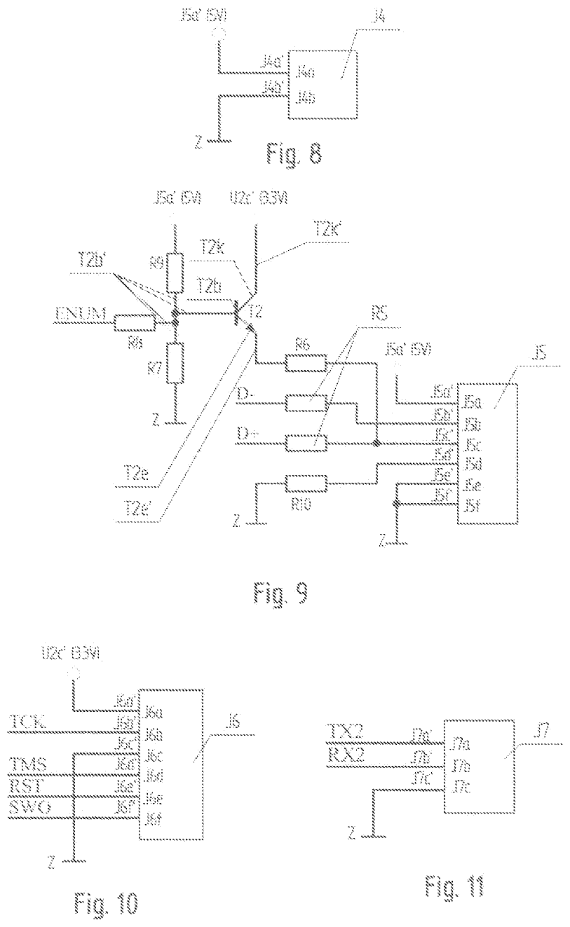

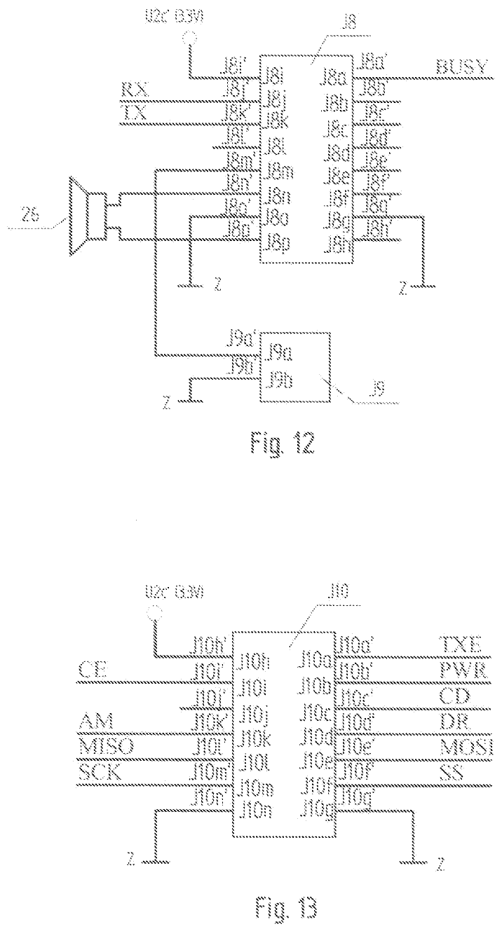

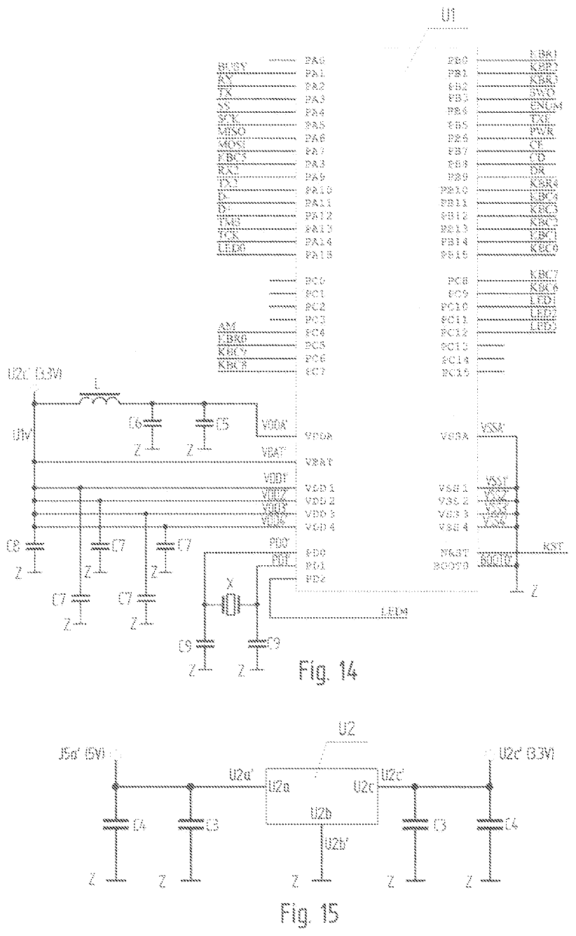

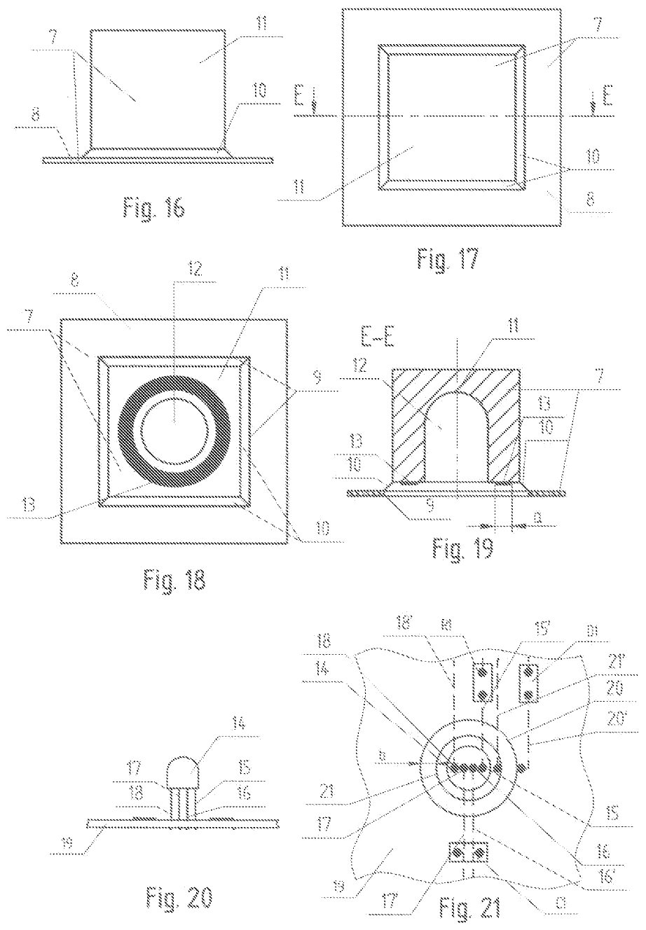

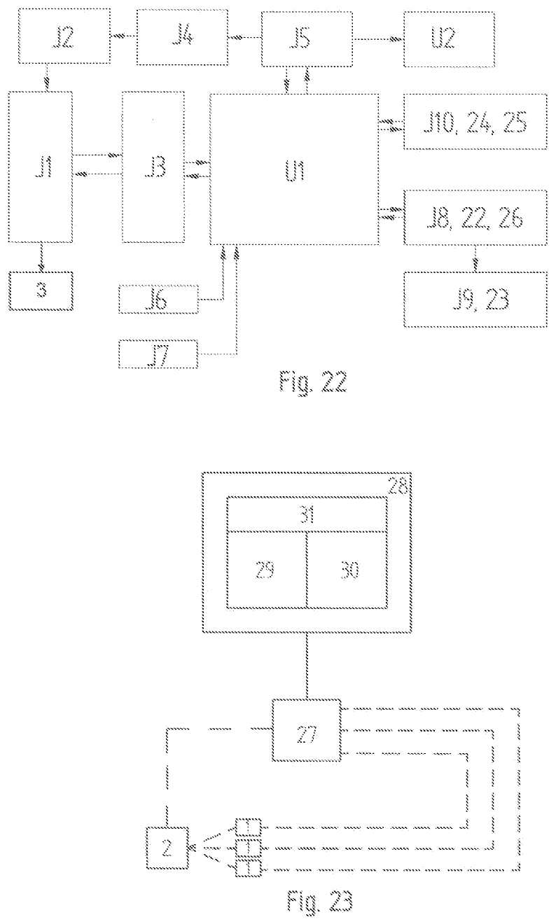

The subject of the invention in its one exemplary embodiment is shown in FIGS. 1-22, where FIGS. 1-15—show electrical diagrams of the slave device, including electrical diagrams of its sockets, FIGS. 16-21—construction of the slave device's working key and a fragment of a PCB with a LED, where FIG. 1 shows an electronic diagram of the connections of the working area, two functional areas and the first electrical working socket of the slave device, FIG. 2—enlarged detail “A” of the first electrical working socket, FIG. 3 enlarged detail “B” of the electronic diagram of the working key of this device, FIG. 4—enlarged detail “C” of the electronic diagram of the first functional key of this device, FIG. 5—enlarged detail “D” of the electronic diagram of the second functional key of this device, FIG. 6—diagram electronic connection diagram of its first electrical power socket, FIG. 7—electronic diagram of connections of the second electrical working socket, FIG. 8—electronic diagram of connections of the second electrical power socket, FIG. 9—electronic diagram of connections of the mini-USB electric plug socket, FIG. 10—electronic diagram of the electrical plug socket connections for programming the microcontroller, FIG. 11—electronic diagram of the electrical plug socket connections for diagnosing the electronics of the slave device, FIG. 12—electronic diagram of the electrical connections of the SD card socket and the socket for the cable plug of the external amplifier, FIG. 13—Electronic diagram of the electrical connection of the socket for the radio communication module, FIG. 14—Electronic diagram of the connection of the slave device's microcontroller, FIG. 15—Electronic diagram of the connection of the power supply stabilizer, FIG. 16—shows the working key of the slave device, without its external overlay, side view, FIG. 17—the same operating key in a top view, FIG. 18—the same working key in a bottom view, FIG. 19—the same operating key in a vertical section along the line E-E, FIG. 20—fragment of the PCB with the LED diode, on which the cuboidal element of the working key is mounted (but without this key) in the side view, FIG. 21—the same fragment of the PCB in the top view, and FIG. 22—block diagram a simplified construction of the slave device and the master device, while FIG. 23 shows a schematic block diagram revealing the principle of operation of the educational device consisting of three slave devices and one master device.

The invention should not be limited to the embodiments described below, as it may also be embodied in other forms. The embodiments are presented so that the disclosure of the invention will be complete and will fully convey the scope of the invention to those skilled in the art.

### Example I

The educational device according to the first variant of its embodiment consists of one slave device 1 and one master device 2, the slave device 1 having a two-piece plastic housing, not shown in the figure, in the upper part of which there are forty-three illuminated keys 3, which, when viewed from above, are forming the working area I and the functional area II located below it, where the working area I consists of forty adjacent working keys 4 arranged in four rows of ten, thus forming rows and columns, and the functional area II consists of two located on both sides of the upper part of the slave device 1, function keys 5 (wider than the operation keys 4), between which there is another function key 6 (the widest of all keys 3).

Each working key 4 (FIG. 16-21) of the slave device 1 consists of one button 7, which is a non-conductive plastic, square, flat base 8 with a through square hole 9 made in its central part, the upper edges of which are welded to the lower the edges of the elastic resilient membrane 10, the upper edges of which are welded to the lower edges of the plastic, semi-transparent, cuboid element 11 with a blind recess 12 made in the middle of its lower surface, with an inverted “U” profile, around which there is an electrically conductive, annular graphite ring path 13 with width “a”. In turn, element 11 is press-fitted to its shape, not shown in the drawing, a key cap made of plastic, the upper surface of which has a transparent symbol of the appropriate working symbol of the working key 4 (e.g. the letter “A”, “B” or “C”). As well, the button 7 is mounted on a luminous LED 14 soldered with its four contacts 15-18 to the upper surface of the polymer flat rectangular PCB 19 of the slave device 1, so that the upper part of the LED 14 sits in the recess 12 of the clement 11 of this button. The contacts 15-18 of the LED 14 are connected to the copper paths 15′-18′ made on the bottom surface of the PCB 19, where the path 15′ of the contact 15 is connected in series with the first contact of the resistor R1 with a resistance of 75Ω, and the paths 16′ and 17′ of each working key 4 are connected in parallel with a capacitor C1 with a capacity of 100 nF, from which path 17′ is further connected in series with ground Z. In turn around the LED 14 on the upper part of the PCB 19 there are two copper ring traks 20 and 21, which are concentrically each other located above the path 13 of the element 11 of the button 7, which are spaced apart by a distance “b”<“a” and connected to the paths 20′ and 21′ made on the PCB 19, the ring path 20 being connected is in series via path 20′ with the first contact of the rectifying diode DI (catalogue number 1N4148).

Each function key 5 has a structure similar to the working key 4, the difference between them being that the function key 5 consists of two buttons 7 located next to each other, with one oblong outer plastic key cap, not shown in the drawing, placed on both of their elements 11. the upper surface of which has a transparent inscription symbolizing the corresponding function of the respective function key 5 (e.g. “SHIFT”, “CTRL”, “CMD”), and furthermore, the path 15′ of the first button 7 of each function key 5 is connected in series with the first contact resistor R1 and with the path 15′ of the second button 7, and the annular path 20 of the first button 7 is connected in series via a copper path 20′ with the first contact of the rectifying diode DI (catalogue number 1N4148) and with the copper path 20′ of the annular path 20 of the second button 7.

The function key 6, on the other hand, has a structure similar to the function key 5, with the difference between them being that the function key 6 consists of four buttons 7 located next to each other in one horizontal row, with one overlay on all four of their elements 11, an elongated plastic key cap, the upper surface of which has a transparent inscription symbolizing the appropriate function of a given function key 6 (e.g. “SPACE”), and also the path 15′ of the first button 7 is connected in series with the first contact of the resistor R1 and with the path 15′ of the remaining buttons 7, and the annular path 20 of the first button 7 is connected in series by a copper path 20′ to the first contact of the rectifying diode DI (catalogue number 1N4148) and to the copper paths 20′ of the annular paths 20 of the other buttons 7.

PCB 19 is soldered to situated inside the housing the electrical working socket J 1 with twenty pins J 1a-J It connected to the paths J 1a′-J If made on the PCB 19 and to the electric power socket J2 with two pins J2a and J2b connected to the made on the PCB 19 paths J2a′ and J2b′, where pin J2a and path J2a′ carry a 5 V power supply, and pin J2b is connected via path J2b′ to ground Z, and paths J2a′ and J2b′ are also connected in parallel with the capacitor C2 with a capacity of 220 pF. At the same time, the working jack J 1 and the power jack J2 are connected via copper paths Jia′-J If and J2a′ and J2b′ to keys 3 of slave device 1, so that:
pins J 1a-J1d of the working socket JI are connected in series by means of paths J 1a′-J Id′ with the second contact of the resistor R1 of each working button 4 located in the first column of working area I, while the paths 18′ of all working keys 4 located in one row of the working area I are connected in series with the second contact of the resistor R1 of the adjacent working key 4, while the paths 18′ of working keys 4 of the last column of working area I are NC paths,
pin J1e of the working socket JI is connected in series by the path J1e′ with the second contact of the resistor R1 of the first button 7 of the first function button 5, whose path 18′ is the NC path, and of the second button 7 is connected in series with the second contact of the resistor R1 of the first button 7 of the function key 6, and the paths 18′ of the first, second and third button 7 of this function key 6 are NC paths, and the path 18′ of the last button 7 of this key is connected in series with the second contact of the resistor R1 of the first button 7 of the second function key 5 whose paths 18′ of both buttons 7 are NC paths,
pins J If-J 1i of the working socket J 1 are connected in series by means of paths J If-J 1i′ with the second contact of the rectifying diode D 1 of each working key 4 located in one row of the working area 1,
pin J Ij of the working socket J 1 is connected in series by the path J Ij′ to the second contact of the rectifying diode D 1 of each function key 5 and 6,
pins J 1 k-J It of working socket J 1 are connected in series by J Ik′-J If paths with copper path 21′ of ring path 21 of each working key 4 of each column of working area I, and additionally J Ip pin is connected in series by J Ip′ path with the copper paths 21′ of the ring paths 21 of both buttons 7 of the first function key 5, pin J 1 q is connected in series by the path J1q′ with the copper paths 21′ of the ring paths 21 of all the buttons 7 of the function key 6, and the pin J Ir is connected in series by the path J 1r′ with copper paths 21′ of the ring paths 21 of both buttons 7 of the second function key 5,
the J2a pin of the J2 power socket is connected in series by the J2a′ path with the 16′ paths of each key 3.

The following are also soldered to the PCB 19:
a second electrical working socket J3 with twenty pins J3a-J3t for a plug of an electric cable not shown in the picture to connect it with socket J 1,
second electrical power socket J4 with two pins J4a and J4b, for the plug of the cable not shown in the picture to connect it with socket J2,
electric socket J5 with six pins J5a-J5f for mini-USB plug of the cable not shown in the picture,
electric socket J6 with six pins J6a-J6f for the plug of the U 1 microcontroller programming cable not shown in the picture, used especially during the production of this device or its servicing,
electrical socket J7 with three pins J7a-J7c for the plug of the cable not shown in the drawing for diagnosing the electronics of the slave device 1, used especially during the production of this device or its servicing,
J8 electrical socket with sixteen pins J8a-J8p for SD 22 card, which is replaceable memory for sound files,
electrical socket J9 with two pins J9a and J9b for the plug of the cable not shown in the drawing to the external amplifier 23,
electrical socket J 10 with fourteen pins J 10a JI On, in which the radio communication module 24 (catalogue number nRF905) equipped with antenna 25 is embedded,
U1 microcontroller (catalogue number STM32F103R) with:
eight pins PAO, PCO-PC3 and PC13-PC15, which are NC pins
pin PA 15 connected to the copper path LEDO made on the PCB 19,
three PC10-PC12 pins connected to the LED1-LED3 copper paths made on the PCB 19,
PD2 pin connected to the LED4 copper path made on the PCB 19,
pin PC5 connected to the copper path KB RO made on the PCB 19,
three PB0-PB2 pins connected to the KBR1-KBR3 copper paths made on the PCB 19,
five pins PB11-PB15 connected to copper paths KBC0-KBC4 made on the PCB 19,
the PA8 pin connected to the KBC5 copper path made on the PCB 19,
four PC6-PC9 pins connected to the KBC6-KBC9 copper paths made on the PCB 19,
pin PA 11 connected to the copper path D− made on the PCB 19,
the PA 12 pin connected to the D+ copper path made on the PCB 19,
pin PB4 connected to the ENUM copper path made on the PCB 19,
pin PA14 connected to the copper path TCK made on the PCB 19,
PA13 pin connected to the TMS copper path made on the PCB 19,
NRST pin connected to the RST copper path made on the PCB 19,
pin PB3 connected to the copper path SWO made on the PCB 19,
the PA9 pin connected to the RX2 copper path made on the PCB 19,
pin PA 10 connected to the copper path TX2 made on the PCB 19,
pin PAI connected to the copper path BUSY made on the PCB 19,
pin PA2 connected to the copper RX path made on the PCB 19,
pin PA3 connected to the copper TX path made on the PCB 19,
pin PB5 connected to the copper TXE path made on the PCB 19,
pin PB6 connected to the copper PWR path made on the PCB 19,
pin PB8 connected to the copper path CD made on the PCB 19,
PB9 pin connected to the DR copper path made on the PCB 19,
PA7 pin connected to the MOSI copper path made on the PCB 19,
pin PA4 connected to the copper SS path made on the PCB 19,
pin PB7 connected to the copper path CE made on the PCB 19,
PC4 pin connected to the copper path AM made on the PCB 19,
PA6 pin connected to the copper MISO path made on the PCB 19,
the PAS pin connected to the SCK copper path made on the PCB 19,
VSSA pin connected to the VS SA′ copper path made on the PCB 19,
four VSS 1-VSS4 pins connected to the VSS 1′-VSS4′ copper paths made on the PCB 19,
VDDA pin connected to the VDDA′ copper path made on the PCB 19,
VBAT pin connected to the VBAT′ copper path made on the PCB 19,
four VDD1-VDD4 pins connected to the VDD1′-VDD4′ copper paths made on the PCB 19,
PDO pin connected to the PDO′ copper path made on the PCB 19,
PD1 pin connected to the PD1′ copper path made on the PCB 19,
U2 power stabilizer with three pins U2a-U2c, where the sockets J3, J4, J6, J7, J10, the microcontroller U 1 and the power stabilizer U2 are located inside the housing of the slave device 1 (not shown in the drawing), and the sockets J5, J8 and J9 are located under the through holes of this housing, which allows for placing in these sockets of the plug of the appropriate cable or SD card 22 when using the device.

The U2a-U2c pins of the U2 power stabilizer are connected to the copper paths U2a′-U2c′ made on the PCB 19 so that:
pin U2a is connected in series by path U2a′ by one of its electrical circuits with capacitor C3 with a capacity of 1OOnF and to the ground Z, the second electrical circuit with capacitor C4 with a capacity of 1OnF and to the ground Z, and the third electrical circuit with the path J5a′ of pin J5a of J5 socket being the power source 5V input,
the U2b pin is connected in series by the U2b′ path with the ground Z
the U2c pin is connected in series by the U2c′ path by first of its electric circuits with the C3 capacitor with a capacity of 1OOnF and to the ground Z, by the second electrical circuit with the capacitor C4 with a capacity of 1OnF and to the ground Z, and the third electrical circuit of this path is a power source with a voltage of 3.3 V

The U2 power regulator converts the 5V input from U2a so that the U2c pin (and its path U2c′) provides an additional 3.3V power source.

The J3a-J3t pins of the working socket J3 are connected to the corresponding pins J 1a-J It of the working socket JI by a cable (not shown in the picture, with two plugs), and the J3a-J3t pins of the J3 socket are connected to the copper traces

J3a′-J3t′ made of on PCB 19, where:
each pin J3a-J3e is connected in series by a copper path J3a′-J3e′ its first circuit with the resistor R2 with a resistance of 4.7 kΩ and with the path J5a′ of the J5apin of the J5 socket constituting a 5 V power source, and its second circuit with drain T1d of the T1 MOSFET transistor (catalogue number BSS 138), whose gate Tig is connected in series with the U2c′ path of the U2c pin of the U2 power regulator, which is a 3.3 V power source, and the T1 source of the T1 transistor is connected to the LED0-LED4 path of the pin PA15, PC10-PC12 and PD2 of the U1 microcontroller, whereby the gate Tig and the source T1 from the transistor T1 are also connected in parallel with the resistor R3 with a resistance of 3.3 kΩ,
each J3f-J3j pin is connected via a copper path J3f-J3j′ with the KBR0-KBR4 path of the PC5 and the PB0-PB2 pins of the U 1 microcontroller,
each J3k-J3t pin is connected by means of a copper J3k′-J3f path by one of its circuit with the KBC0-KBC9 path of the PB11-PB15, PA8 and PC6-PC9 pins of the U 1 microcontroller, and by the another circuit with the first contact of the resistor R4 with a resistance of 3, 3 kΩ, each of which is connected by its second contact with ground Z.

The J4a and J4b pins of the J4 power socket are connected to the corresponding too them J2a and J2b pins of the J2 power socket by means of a cable (not shown in the picture, with two plugs), and the J4a and J4b pins of the J4 socket are connected to the copper traces J4a′ and J4b′ made of on PCB 19, where:
the J4a pin is connected via the J4a′ path to the J5a′ path of the J5a pin of the J5 socket, which is a 5V power source,
pin J4b is connected via path J4b′ to ground Z.

The J5a-J5fpins of the J5 socket are connected to the copper paths J5a′-J5f made on the PCB 19, where:
pin J5a (and its path J5a′) are a power source with a voltage of 5 V (after connecting a cable of power source not shown in the picture to this plug socket),
the J5b pin is connected in series by the J5b′ path with the 22Ω resistor R5 and the D− path of the PAI 1 pin of the U 1 microcontroller,
pin J5c is connected in series by path J5c′ by one electric circuit with resistor R5 with resistance of 22Ω and with path D+ of pin PA12 of microcontroller U 1, and by the second electric circuit in series with resistor R6 with resistance of 1.5 kΩ, which is also connected with copper path T2e′ of the emitter T2e of the transistor T2 of npn type (catalogue number BC817), whose collector T2k is connected to the path U2c′ of the U2c pin of the power stabilizer U2, which is a 3.3 V power source, and the base T2b of the transistor T2 is connected in series by the copper path T2b′ its first electric circuit with a 36 kΩ resistor R7 and with the ground Z, the second electric circuit with a 100Ω resistor R8 and to the ENUM path of the PB4 pin of the U 1 microcontroller, and the third circuit with a 10 kΩ resistor R9 and with the J5a′ path of the J5a pin of J5 socket as a 5 V power source,
the J5d pin is connected in series by the J5d′ path with the resistor RIO with a resistance of 100 kΩ and ground Z,
pins J5e and J5f are connected in series to each other via J5e′ and J5f paths and with ground Z.

The J6a-J6f pins of the J6 socket are connected to the copper paths J6a′-J6f made on the PCB 19, where:
the J6a pin is connected in series by the J6a′ path with the U2c′ path of the U2c pin of the U2 power stabilizer, which is a 3.3 V power source,
J6b pin is connected in series by the J6b′ path with the TCK path of the PA14 pin of the U 1 microcontroller,
J6c pin is connected in series by the J6c′ path with ground Z,
J6d pin is connected in series by the J6d′ path with the TMS path of the PA 13 pin of the

U 1 microcontroller,. the J6e pin is connected in series by the J6e′ path with the RST path of the NRST pin of the U 1 microcontroller,
J6f pin is connected in series by the J6f path with the SWO path of the PB3 pin of the U 1 microcontroller.

The J7a-J7c pins of the J7 socket are connected to the copper paths J7a′-J7c′ made on the PCB 19, where:
J7a pin is connected in series by the J7a′ path with the TX2 path of the PA10 pin of the U 1 microcontroller,
J7b pin is connected in series by the J7b′ path with the RX2 path of the PA9 pin of the U 1 microcontroller,
pin J7c is connected in series by path J7c′ with ground Z.

The pins J8b-J8f, J8h and J8l of the J8 socket are NC pins, while the remaining pins J8a, J8g, J8i-J8k, J8m-J8p are connected to copper paths J8a′, J8g′, J8i′ J8k′, J8m′-J8p′ made of on PCB 19, where:
the J8a pin is connected in series by the J8a′ path with the BUSY path of the PAI pin of the U 1 microcontroller,
J8g and J8o pins are connected in series by paths J8g′ and J8o′ with ground Z,
the J8i pin is connected in series by the J8i′ path with the U2c′ path of the U2c pin of the U2 power stabilizer, which is a 3.3 V power source,
J8j pin is connected in series by the J8j′ path with the RX path of the PA2 pin of the U 1 microcontroller,
J8k pin is connected in series by the J8k′ path with the TX path of the PA3 pin of the U 1 microcontroller,
pin J8m is connected in series by path J8m′ with path J9a′ of pin J9a of socket J9,
J8n and J8p pins are connected in series by path J8n′ and J8p′ with the loudspeaker 26, which is located inside the housing of the slave device 1 (not shown in the picture) and is glued to the PCB 19.

The J9a and J9b pins of the J9 socket are connected to the copper paths J9a′ and J9b′ made on the PCB 19, where:
the J9a pin is connected in series by the J9a′ path with the J8m′ path of the J8m pin of the J8 socket,
pin J9b is connected in series by the path J9b′ with the ground Z.

The J1Oj pin of the J 10 socket is the NC pin, and the remaining J1Oa-J1Oi and J 1Ok-J 1On pins are connected to the copper paths J 10a′-J10i′ and J1Ok′-J 10n′ made on the PCB 19, where:
J 10a pin is connected in series by the J 10a′ path with the TXE path of the PB4 pin of the U 1 microcontroller,
J 10b pin is connected in series by the J 1 Ob′ path with the PWR path of the PB6 pin of the U 1 microcontroller,
the J 10c pin is connected in series by the J 10c′ path with the CD path of the PB8 pin of the U 1 microcontroller,
J 1Od pin is connected in series by the J1Od′ path with the DR path of the PB9 pin of the U 1 microcontroller,
J 1Oe pin is connected in series by the J1Oe′ path with the MOSI path of the PA7 pin of the U 1 microcontroller,
J 1Of pin is connected in series by the J1Of path with the SS path of the PA4 pin of the U 1 microcontroller,
pins J 10g and J1On are connected in series by paths J 10g′ and J 10n′ with ground Z,
the J1Oi pin is connected in series by the J 10i′ path with the CE path of the PB7 pin of the U 1 microcontroller,
J 10k pin is connected in series by the J 1 Ok′ path with the AM path of the PB8 pin of the U 1 microcontroller,
J 10l pin is connected in series by the J 10l′ path with the MISO path of the PA6 pin of the U 1 microcontroller,
the J 10m pin is connected in series by the J10m′ path with the SCK path of the PAS pin of the U 1 microcontroller.

In turn, the VSSA, BOOTO and VSS1-VSS4 pins of the U1 microcontroller are connected to the Z ground via the VSSA′, BOOTO′ and VSS1′-VSS4′ paths, while:
the VDDA pin of the U 1 microcontroller is connected in series by the VDDA′ path by the first of its electrical circuit with the capacitor C5 with a capacity of 1OOnF, and with the ground Z, by the second electrical circuit with the capacitor C6 with the capacity of 1 pF, and then with the ground Z, the third circuit with the coil L with the inductance 10 H, then with U1v′ path,
the VBAT pin of the U 1 microcontroller is connected in series by the VBAT′ path and the U 1 v′ path,
each VDD1-VDD4 pin of the U1 microcontroller is connected in series by the VDD1′-VDD4′ path, its one electric circuit with the 100 nF capacitor C7, and then with the ground Z, and the second electric circuit with the U 1 v′ path,
the U 1v′ path is made on the PCB 19 and connects to the U2c′ path of the U2c pin of the U2 power stabilizer, which is a 3.3 V power source and with the C8 capacitor with a capacity of 4.7 pF and with the VDDA′, VBAT′ and VDD1′-VDD4′ paths of VDDA, VBAT and VDD1-VDD4 pins of U1 microcontroller,
the PDO and PD1 pins of the U 1 microcontroller are connected in series by the PDO′ and PD1′ paths with the capacitor C9 with a capacity of 30 pF and then with the ground Z, and these paths are connected in parallel with the X quartz resonator with a frequency of 8 MHz.

Further as well, the slave device 1 is equipped with a button, not shown in the figure, for switching the power on or off of the device.

The master device 2, on the other hand, has a structure similar to the slave device 1, but the difference between these two devices is that the PCB 19 of the master device 2 does not have LEDs 14, resistors R1 and capacitors C1 (keys 3 of the master device 2 do not are backlit).

### Example II

In the second embodiment of the educational device according to the invention, not shown in the drawing, the slave device 1 and the master device 2 have a structure similar to the slave device 1 and the master device 2 according to the first variant, whereby these devices do not have sockets J9 and socket J5, resistors R5-R10 and transistor T2, as well the 5V power supply for these devices were batteries, which were connected to an electrical path replacing the J5a′ path of the J5a pin of the J5 socket, and the J8m′ path of the J8m pin of the J8 socket and the ENUM, D− and D+ paths of the PB4, PA 11 and PA 12 pins of the U 1 microcontroller were NC paths. Further, a module for wireless communication was plugged into the socket J7, which then enabled wireless communication of these devices with an external computer 27, screen 28 or another electronic device in this latter version. It is obvious that in this second embodiment of the invention, accumulators may be used instead of batteries.

It is also obvious that the educational device may consist of one master device 2 and two, five, ten, or more slave devices, depending on the number of users (students).

The principle of operation of the educational device according to the invention is that after connecting the slave device 1 and master device 2 to the power supply, inserting the SD cards 22 with recorded audio data into their slots J8, and connecting them to the computer 27 equipped with the screen 28 and starting the appropriate program controlling these devices-the master device 2, depending on this program, by means of its radio communication module 24 with antenna 25, transmits radio signals (wirelessly) to the antenna 25 of the radio communication module 24 of the slave device 1, and these signals are transmitted:
after pressing the key 3 of the master device 2, powered from the connected power sockets J2 and J4, which causes the electric signal from this key 3 to pass through the connected working sockets J 1 and J3 to its microcontroller U1, which then sends the appropriate electric signal to the socket J 10 and a radio communication module 24 generating said radio signals, sending them further through the antenna 25,
similarly, but without pressing the keys 3, through the electrical signals generated by the microcontroller U1 of the master device 2, which pass to the socket J 10 and the radio communication module 24 generating said radio signals, sending them further through the antenna 25, while at the same time the microcontroller U1 of the master device 2 generates electrical signals to jack J8 and, using the audio data contained in the SD card 22, produces the corresponding sound from the loudspeaker 26 or amplifier 23 (if previously connected to jack J9 of master device 2).

At the same time, the radio signal that has reached the slave device 1 is converted in the radio communication module 24 into an electrical signal and goes to the microcontroller U1 of this device, which then generates an electrical signal passing through the interconnected working sockets J 1 and J3 so that it goes to the diode LED 14 of the key 3 of this device corresponding to the pressed key 3 on the master device 2 (or according to the electrical signal converted into a radio signal sent by the microcontroller U 1 of the master device 2), causing the illumination of the key 3.

In turn, when the user of slave device 1 (student) presses this illuminated key 3, the electrical signals from this key (powered from the interconnected power sockets J2 and J4) are sent through the interconnected working sockets JI and J3 to its microcontroller U1, which then sends the appropriate electrical signal to the J5 or J7 socket connecting this device with the computer (wired or wireless) and processes this information accordingly, and at the same time the U 1 microcontroller generates an electrical signal to the J8 socket and, using the sound data contained in the SD card 22, produces the appropriate sound coming from loudspeaker 26 or amplifier 23 (if previously connected to socket J9 of slave device 1).

However, if the student presses the wrong key 3 of slave device 1, the electrical signals from this key (powered from the interconnected power sockets J4 and J2) are sent through the interconnected working sockets J 1 and J3 to his microcontroller U1, which generates only an electrical signal to socket J8 and using the audio data contained in the SD card 22 produces the corresponding sound from the loudspeaker 26 or the amplifier 23 (if previously connected to socket J9 of slave device 1).

There are two ways to use the device. The first version of the possibility is the one in which the leading teacher conducts the classes, and the second version is without the participation of the leading teacher.

In the first version, conducted under the supervision and with the help of a master device keyboard, these can be individual and group teaching classes. Here, the teacher dictates to the student the words provided for a given series of tasks detecting individual letter sequences by the device.

In the second version, without the participation of the teacher, which is intended only for classes of individual interaction of the student with the device that assigns the student subsequent tasks and controls the pace of solving subsequent tasks by the student. This option allows you to conduct classes by using an appropriately developed program of sound recording cycles emitted from the loudspeaker of the master device keyboard in the absence of the teacher.

### Example III

The method of learning to write according to the first version of the device consists of the following stages:
I. the teacher (user of the master device 2) turns on the power supply of the master device 2 and the power supply of the slave devices 1 of the students (users of the slave devices 1), then inserts the SD cards 22 with the recorded sound data into the J8 slots of these devices and connects these devices to the mains-powered computer 27 equipped with a screen 28 (wired—using mini-USB cables, each first plug of which is located in the computer's socket, and each second plug in the J5 socket of each slave and master device, or wirelessly—using a wireless communication module embedded in socket J7 of these devices),
II. the teacher activates on the computer 27 a program containing a text editor 29 and a module for handling 31 of the master device 2 and slave devices 1, on which he runs a selected series of tasks for recognizing letter sequences by the device, and then assigns the student a task, e.g. “dom” (polish—, house”—translator's footnote),
III. for this purpose, the teacher simulates solving the task on the master device 2 by pressing the appropriate keys 3 of the master device 2 at a pace chosen by him (for example, in this case, the working keys 4 marked with the letters “D”, “O”, “M”), and then the master device 2 simultaneously radio communicates with each slave device 1 by means of their radio communication modules 24 and antennas 25 thereby turning on the LEDs 14 of the keys 3 of the slave device 1 corresponding to the pressed keys 3 on the master device 2 (according to the implementation of this task) causing their backlight, and when the teacher stops pressing the keys 3 of the master device 2, the LEDs 14 of the keys 3 of the slave device 1 automatically go out. If necessary, the teacher encourages the students to perform the task many times, for this purpose he or she pronounces the phrase corresponding to the selected task several times, and additionally, when he presses each of the keys 3, he pronounces the given letter corresponding to the given key. In this situation, the teacher in charge, if necessary, by repeatedly pressing individual buttons and pronouncing letters simultaneously, does so at the right pace and in a methodically adequate way to obtain the desired reaction of the student to flawlessly perform the letter sequence, i.e. also consisting in the fact that while pressing successive keys and pronouncing the letters, he moves on to fluently combining the sounds of letters into the sound of a word, which makes it easier for the student to solve the task,
IV. the student presses keys 3 on his slave device 1 and slave device 1 generates a sound coming from his speaker 26, which is appropriately assigned to each of the keys 3, and in the case when he presses all the keys required for a given task 3 in the correct order and performs flawlessly the sequences of letters as “D”, “O”, “M”, then the loudspeaker of the slave device, the student's keyboard emits the appropriate sound signal of completing the given task, and the text editor displays correctly pressed letters forming the given word DOM,
V. in the event that the student presses any key without performing the task, slave device 1 generates a sound from its speaker 26 corresponding to that key 3, and the task is not performed and the letter is not displayed.

### Example IV

The of educational device-assisted writing learning method according to its second version consists of the following stages:
I. the teacher turns on the power supply of the master device 2 and the power supply of the slave device 1, then inserts the SD card with recorded sound data into the J8 socket of this device and connects this device with a computer powered from the mains 27 equipped with a screen 28 and a speaker,
II. the teacher activates on the computer 27 a program containing a text editor 29, an animation window 30 and a module for handling 31 of the master device 2 and the slave device 1, on which he activates an automatic subroutine that runs a series of tasks selected by him that will be performed by the student. If necessary, the teacher also activates on the screen 28 in the handling module 31 the options of generating dictation sounds in the loudspeaker 26 of the master device 2, sounds corresponding to the phrase constituting the solution to a given task, and then sends a signal to the slave device 1 (according to the implementation of a given cycle of tasks and starts for example, the task of writing the word “D O M” (polish—, house”—translator's note),
III. the U1 microcontroller of the master device 2 simulates the solution of the task on the master device 2 by sending the appropriate electrical signals at a rate set in the subprogram and for a given time to the radio communication module 24 of this device, while the master device 2 simultaneously communicates by radio with the slave device 1 using their modules radio communication 24 and antennas 25, thereby turning on the LEDs 14 of the keys 3 of the slave device 1 corresponding to the electrical signals sent by the microcontroller U 1 of the master device 2 (according to the implementation of this task) causing them to be lit, and when the electrical signals sent by the microcontroller U 1 are not sent to the radio communication modules 24 of the master device 2, LEDs 14 of the keys 3 of the slave device 1 automatically go out. At this time, i.e. during the illumination and extinguishing of the diodes, the loudspeaker of the master device simultaneously emits a recording sound of dictations corresponding to the illuminated diodes.
IV. Then the student presses the keys 3 on his slave device 1, and if:
a) the student presses the non-illuminated key 3, the slave device 1 generates a sound that comes out of its loudspeaker 26, signalling an error,
b) the student presses the illuminated key 3, the symbol corresponding to this key appears on the screen 28 in the text editor 29, and in addition the slave device 1 generates a sound coming from its loudspeaker 26 that corresponds to this key 3,
c) regardless of any mistakes made, the student presses in the correct order all the illuminated keys required for a given task and during their illumination, the loudspeaker of the subordinate device of the student's keyboard emits an appropriate sound signal of completing the given task, on screen 28 the animation window 30 display animations and graphics signalling the correct completion of the given task, after which the program proceeds to perform the next task provided for the student,
d) the student fails to complete the task correctly within the maximum time provided for the given task, the given task is performed again,
e) the student stops solving the tasks completely, or presses several keys (minimum four) at the same time, the device goes into sleep mode When the keyboard wakes from sleep mode, the device returns to the task that was previously interrupted.

After completing the cycle of tasks, the teacher selects the next cycle of tasks on the screen 28 in the module for handling 31.

It is obvious that the teacher in any embodiment of the present method of learning to write with the use of the educational device according to the invention can also connect these slave devices 1 and the master device 2 with an external amplifier 23 by means of sockets J9 and the appropriate cable, before or after handing over the slave devices 1 to the students, and it is also possible to learn to write using the educational device according to the invention without voice commands (pronunciation of phrases by the teacher, or generation of sounds corresponding to the phrase and letters by the microcontroller, which come from the loudspeaker 26 of the master device 2), which is applicable for separate exercises, including in the case of teaching deaf people to write. In addition, it is possible that, while solving each task by students, graphics and animations appear on the screen 28 in the animation window 30, visually presenting the meaning of the phrase according to the given task (for example, a drawing or video, inscription, sign language for the deaf, showing the house in the case of when the task is to enter the phrase “DOM” (, house”—translator's note).

Moreover, it is also advantageous and possible for blind people to use the exercises of only the slave device 1. They can use them to learn writing, including Braille. It is also obvious that each slave device keyboard can be connected to an independent PC and computer screen using an independent text editor.

This description of the structure is conditioned by its target function, i.e. the function of teaching in early childhood and the structure adapted for this purpose with a limited number of keys. It should also be obvious, if necessary, to extend the construction of the device with the use of additional keys for advanced students, i.e. the full structure of a generally accepted computer keyboard-including its Polish version-the option to press two keys at once. The arrangement and use of these keys is generally identical in different countries and by different software and different alphabet options by using the same keys, as far it presents a customary throughout the world similar arrangement of using generally and widely accepted, a standard use computer keyboard.

The educational device significantly facilitates the work of the teacher and accelerates the learning of writing, reading, pronouncing letters and words, including in a foreign language, especially by small children. Thanks to the software with which the device according to the invention is equipped, it is possible to shorten the process of teaching literacy, implement it earlier and increase the number of students with whom the teacher can work simultaneously. The method of teaching writing using the educational device of the invention significantly reduces the time needed for students to learn and increases the effectiveness of this teaching method.

Illuminated keys of the slave device during the student's exercises, as well as the sounds of individual letters emitted from the speaker of the slave device at a given time and circumstances, cause the student to get used to the keys, sounds corresponding to the given signs of letters and the arrangement of letters on the keyboard, which allows as a consequence, he is able not only to use any computer keyboard on his own, but above all to associate and consolidate the letters themselves. The consolidation of letters by the student translates into faster development of the skills of reading and conscious use of letters, as well for independent writing, including copying letters in the form of hand-drawing, whereby manual-drawing exercises are not necessary at all to learn to write, because the key and completely sufficient to learn to write is to acquire the ability to associate and use letters.

Thanks to the fact that the slave and master devices are equipped with a loudspeaker generating sounds (or can be connected to an additional external amplifier), the student learns much faster and easier by listening to syllabic dictations, as well as the sounds of letters and the composition of the letters of individual words, their association and mastering. By associating sounds corresponding to individual letters, syllables or words and combining them with symbols of letters, the student, guided by his natural participation reflex, learns to recognize and pronounce these letters, syllables and words, perfecting pronunciation and developing awareness of word structure and speech structure, which translates into in turn, on shaping his ability to speak, read and write correctly, but also on self-organization skills in the overall development plane.

This is possible as well due to the fact that after turning on the power, the slave device and placing the SD card 22 with recorded audio data in the J8 slot, connecting it with the computer 27 equipped with the screen 28 and switching on a special mode of the software controlling this device-this software works in such a way, that when any key 3 is pressed, its speaker 26 generates a sound corresponding to that key, thereby informing the user which key 3 has been pressed (e.g., when the letter “B” is clicked, a “b” sound is generated in the speaker of the sub-keyboard).

Beneficial and justified in this aspect, due to the possibility of enabling the learner to better associate the structure of a word, is the use of voice recordings adapted in a way that is methodically adequate in terms of translating phonetics into letter signs. The solution to obtain the proper transparency of the letter structure of a given word, e.g. for the Polish alphabet, is to pronounce the letters in a simplified way in terms of their basic sounds, without additional prefixes and endings, i.e. the sounds “e”, “a”, “ot”, “et”.

Thanks to the program of the automatic version of the device, including the use of audio-video animations, the child learns the meaning of the recorded words and concepts in an accessible and fun way, developing their knowledge and developing the need to use broadly and generally understood reading. The use of the method of teaching reading and writing with the use of the educational device according to the invention thus significantly improves the quality of teaching in the undertaken field, reduces the time needed for students to learn and increases the effectiveness of this teaching method.

1. An educational device consisting of a master device and at least one slave device, each of which has a plastic housing with keys, inside which there is an electrically powered PCB with a microcontroller equipped with software, characterized in that the PCB (19) of each the slave (1) and the master (2) devices have inseparably connected to them and located inside the housing: power supply stabilizer (U2), two working sockets (J1, J3) connected with each other by an electric cable, two power sockets connected with each other by an electric cable (J2, J4), socket (J6) for the plug of the cable for programming the microcontroller (U1), socket (J7) for the plug of the cable for diagnosing electronics, socket (J8) for the SD card (22) electrically connected to the loudspeaker (26) connected inseparably with the PCB (19), the socket (J10) with the radio communication module (24), with the antenna (25) embedded in it, and:
the microcontroller (U1) is electrically connected to the ground (Z) and to the power supply stabilizer (U2), which together with the working socket (J3) and the power socket (J4) are electrically connected to the power source and the ground (Z),
sockets (J6, J8, J10) are electrically connected to the microcontroller (U1), power supply stabilizer (U2) and ground (Z),
socket (J7) is electrically connected to the microcontroller (U1) and ground (Z),
the power socket (J2) is electrically connected to the ground (Z), and together with the working socket (J1) it is electrically connected to the buttons (7) of the keys (3), the keys (3) of the slave (1) being equipped with LEDs (14).

2. An educational device according to claim 1, characterized in that the keys (3) form a working area (I) and a functional area (II), wherein the working area (I) consists of working keys (4) arranged in rows forming rows and columns, each of which has one button (7), and the functional area (II) consists of one function key (6) having four buttons (7) placed between two function keys (5), each of which has two buttons (7).

3. An educational device according to claim 1 or 2, characterized in that the button (7) of the key (3) is a plastic flat base (8) with a through hole (9) made in its central part, the upper edges of which are inseparably connected with the lower edges of the resilient membrane (10), the upper edges of which are inseparably connected to the lower edges of the plastic, semi-transparent, cuboid element (11) with a blind recess (12) with an inverted “U” profile made in the middle part of its lower surface, around which there is a graphite annular path (13) of width (a), and, the button (7) is mounted on the PCB (19) with two copper ring paths (20, 21) located concentrically to each other and located above the ring track (13) of the element (11) spaced apart by a distance (b) less than a width (a) of the annular track (13) and connected to the tracks (20′, 21′) made on the PCB (19), the annular track (20) being connected in series by a copper track (20′) to the first contact of the rectifying diode (D1), and the annular track (21) is electrically connected to the first working socket (J1) by means of a copper track (21′).

4. An educational device according to claim 3, characterized in that on the element (11) of the button (7) of each working key (4) there is a plastic overlay, on the upper surface of which there is a transparent symbol of the corresponding working sign of the key (4), on the elements (11) of both buttons (7) of each function key (5), there is as well a plastic overlay, on the upper surface of which there is a transparent symbol of the appropriate function key (5), and on the elements (11) of all four buttons (7) of the function key (6), there is a plastic overlay on the upper surface of which there is a transparent symbol of the corresponding key function sign (6).

5. An educational device according to claim 1 or 2 or 3 or 4, characterized in that the button (7) of each key (3) of the slave device (1) is mounted on a luminous LED (14) inseparably connected by its four contacts (15, 16, 17, 18) with PCB (19) so that the upper part of the LED (14) is embedded in the lower recess (12) of the element (11) of the button (7), and the contacts (15, 16, 17, 18) of the LED (14) are connected electrically with four copper tracks (15′, 16′, 17′, 18′) made on the surface of the PCB (19).

6. An educational device according to claim 5, characterized in that the first track (15′) of the contact (15) of the LED (14) of the button (7) of each working key (4) of the slave device (1) is connected in series with the first contact of the resistor (R1), and the second track (16′) and the third track (17′) of the second and third contacts (16, 17) of this LED (14) are connected in parallel with the capacitor (C1), this second track (16′) being also electrically connected to the first power socket (J2), and the third track (17′) is also connected in series with the ground (Z), and the fourth track (18′) of the fourth contact (18) of the LED (14) of each working key (4) located in one working area row (I) is connected in series with the second resistor contact (R1) of the adjacent work key (4), the fourth track (18′) of each work key (4) of the last column of work area (I) being the NC track.

7. An educational device according to claim 5 characterized in that the first track (15′) of the contact (15) of the LED (14) of the first button (7) of each function key (5) of the slave device (1) is connected in series with the first contact of the resistor (R1) and with the track (15′) of the second button (7), and the second track (16′) and the third track (17′) of this LED (14) are connected in parallel with the capacitor (C1), the second track (16′) being also electrically connected with the power socket (J2), and the third track (17′) is also connected in series with the ground (Z), and the fourth track (18′) of the first button (7) of the function key (5) is the NC path, and of the second button (7) is connected in series with the second contact of the resistor (R1) of the first button (7) of the function key (6), and the paths (18′) of both buttons (7) of the second function button (5) are NC paths, and also paths (20′) both buttons (7) of each function key (5) of slave (1) and master (2) are connected in series to each other.

8. An educational device according to claim 5 characterized in that the first track (15′) of the contact (15) of the LED (14) of the first button (7) of the function key (6) of the slave device (1) is connected in series with the first contact of the resistor (R1) and the track (15′) of the second, third and fourth buttons (7), and the second track (16′) and the third track (17′) of the second and third contacts (16, 17) of said LED (14) are connected in parallel with the capacitor (C1), wherein the second track (16′) is also electrically connected to the first power socket (J2), and the third track (17′) is also connected in series with ground (Z), and the fourth track (18′) of the fourth contact (18) of the first, second and third buttons (7) of the function key (6) are the NC path, and the fourth button (7) is connected in series with the second contact of the resistor (R1) of the first button (7) of the function key (5), and also the paths (20′) of the four buttons (7) of the slave device (1) and the master device (2) are connected in series to each other.

9. An educational device according to claim 1. Characterized in that the first working socket (J1) has twenty pins (J1a-J1t) connected to the tracks (J1a′-J1t′) made on the PCB (19), and the first power socket (J2) has two pins (J2a, J2b) connected to the paths (J2a′, J2b′) made on the PCB (19), where the first pin (J2a) and the path (J2a′) of the first power socket (J2) are carrying the power supply, and the second pin (J2b) is connected via the path (J2b′) with the ground (Z), and furthermore both paths (J2a′, J2b′) of the power socket (J2) are connected in parallel with the capacitor (C2).

10. An educational device according to claim 9, characterized in that the pins (J1a-J1t) of the first working socket (J1) are connected by means of copper paths (J1a′-J1t′) with the keys (3) so that:
the first four pins (J1a-J1d) of the first working socket (J1) are connected in series by means of paths (J1a′-J1d′) with the second contact of the resistor (R1) of each working button (4) located in the first column of the working area (I),
the fifth pin (J1e) of the first working socket (J1) is connected in series by the path (J1e′) to the second contact of the resistor (R1) of the first button (7) of the first function key (5),
four consecutive pins (J1f-J1i) of the first working socket (J1) are connected in series by means of paths (J1f′-J1i′) with the second contact of the rectifying diode (D1) of each working key (4), each located in one line of the working area (I),
the next pin (J1j) of the first working socket (J1) is connected in series by the path (J1j′) to the second contact of the rectifying diode D1 of each function key (5, 6),
the next ten pins (J1k-J1t) of the first working socket (J1) are connected in series by means of tracks (J1k′-J1t′) with the copper track (21′) of the ring track (21) of each working key (4) of each column of the working mode area (I), and additionally, the sixteenth pin (J1p) is connected in series by a track (J1p′) with the copper tracks (21′) of the ring tracks (21) of both buttons (7) of the first function key (5), the seventeenth pin (J1q) is connected in series by a track (J1q′) with the copper tracks (21′) of the annular tracks (21) of all buttons (7) of the function key (6), and the eighteenth pin (J1r) is connected in series by a track (J1r′) with the copper tracks (21′) of the annular tracks (21) of both buttons (7) of the second function key (5).

11. An educational device according to claim 1, characterized in that the second working socket (J3) has twenty pins (J3a-J3t) connected to the tracks (J3a′-J3t′) made on the PCB (19), the second power socket (J4) has two pins (J4a, J4b) connected to the paths (J4a′, J4b′) made on the PCB (19), where the pin (J4a) of this socket is connected by means of the path (J4a′) to the 5V power source, and the pin (J4b) with the path (J4b′) is connected to the ground (Z), the socket (J6) has six pins (J6a-J6f) connected to the paths (J6a′-J6f) made on the PCB (19), the socket (J7) has three pins (J7a-J7c) connected to the tracks (J7a′-J7c′) made on the PCB (19), the socket (J8) has sixteen pins (J8a-J8p) connected to the tracks (J8a′-J8p′) made on the PCB (19)), the socket (J10) has fourteen pins (J10a-J10n) connected to the tracks (J10a′-J10n′) made on the PCB (19), the power stabilizer (U2) has three pins (U2a-U2c) connected to the tracks (U2a′-U2c′) made on the PCB (19) and the microcontroller (U1) has:
eight pins (PA0, PC0-PC3, PC13-PC15) which are NC pins,
pin (PA15) connected to path (LED0),
three pins (PC10-PC12) connected to paths (LED1-LED3),
pin (PD2) connected to path (LED4),
pin (PC5) connected to path (KBR0),
three pins (PB0-PB2) connected to paths (KBR1-KBR3),
five pins (PB11-PB15) connected to tracks (KBC0-KBC4),
pin (PA8) connected to track (KBC5),
four pins (PC6-PC9) connected to paths (KBC6-KBC9),
pin (PA11) connected to track (D−),
pin (PA12) connected to track (D+),
pin (PB4) connected to path (ENUM),
pin (PA14) connected to track (TCK),
pin (PA13) connected to path (TMS),
pin (NRST) connected to track (RST),
pin (PB3) connected to path (SWO),
pin (PA9) connected to path (RX2),
pin (PA10) connected to track (TX2),
pin (PA1) connected to path (BUSY),
pin (PA2) connected to path (RX),
pin (PA3) connected to track (TX),
pin (PB5) connected to path (TXE),
pin (PB6) connected to path (PWR),
pin (PB8) connected to path (CD),
pin (PB9) connected to track (DR),
pin (PA7) connected to path (MOSI),
pin (PA4) connected to path (SS),
pin (PB7) connected to path (CE),
pin (PC4) connected to path (AM),
pin (PA6) connected to path (MISO),
pin (PA5) connected to track (SCK),
pin (VSSA) connected to path (VSSA′),
four pins (VSS1-VSS4) connected to paths (VSS1′-VSS4′),
pin (VDDA) connected to path (VDDA′),
pin (VBAT) connected to track (VBAT′),
four pins (VDD1-VDD4) connected to paths (VDD1′-VDD4′),
pin (PD0) connected to path (PD0′),
pin (PD1) connected to path (PD1′), where paths (LED0-LED4, KBR0-KBR3, KBC0-KBC9, D−, D+, ENUM, TCK, TMS, RST, SWO, RX2, TX2, BUSY, RX, TX, TXE, PWR, CD, DR, MOSI, SS, CE, AM, MISO, SCK, VSSA′, VSS1′-VSS4′, VDDA′, VBAT′, VDD1′-VDD4′, PD0′, PD1′) are made on the PCB (19).

12. An educational device according to claim 11, characterized in that the first pin (U2a) of the power stabilizer (U2) is connected in series by a path (U2a′) by one of its electrical circuits with the first capacitor (C3) and ground (Z), the second electrical circuit with the second capacitor (C4) and ground (Z), and the third electrical circuit with a 5V input power source, the second pin (U2b) of the power stabilizer (U2) is connected in series by the path (U2b′) with the ground (Z), and the third pin (U2c) of the power stabilizer (U2) is connected in series by a path (U2c′) by first of its electrical circuits with the third capacitor (C3) and ground (Z), its second electrical circuit with the fourth capacitor (C4) and ground (Z), and the third electrical circuit of this path is a 3.3V power source.

13. An educational device according to claim 11, characterized in that each of the pins (J3a-J3e) of the second working socket (J3) is connected in series by means of a path (J3a′-J3e′) of its first circuit with a resistor (R2) and a 5V power source, its the second circuit with the drain (T1d) of the transistor (T1) of the MOSFET type, the gate (T1g) of which is connected in series with the path (U2c′) of the pin (U2c) of the power stabilizer (U2), and the source (T1z) of the transistor (T1) is connected to the path (LED0-LED4) of the pin (PA15, PC10-PC12, PD2) of the microcontroller (U1), the gate (T1g) and the source (T1z) of the transistor (T1) are also connected in parallel with the resistor (R3), each pin (J3f-J3j) of the second working socket (J3) is connected by a path (J3f-J3j′) with a path (KBR0-KBR4) of the pins (PC5, PB0-PB2) of the microcontroller (U1), and each pin (J3k-J3t) of the second working socket (J3) is connected by means of a path (J3k′-J3t′) by one circuit with the path (KBC0-KBC9) of the pin (PB11-PB15, PA8, PC6-PC9) of the microcontroller (U1), and by the second circuit with the first contact of resistor (R4), each of which is connected by its second contact with the ground (Z).

14. An educational device according to claim 11, characterized in that the first pin (J6a) of the socket (J6) is connected in series by the path (J6a′) with the path (U2c′) of the pin (U2c) of the power supply stabilizer (U2), the second pin (J6b) of the socket (J6) is connected in series by path (J6b′) with path (TCK) of pin (PA14) of microcontroller (U1), third pin (J6c) of socket (J6) is connected in series by the path (J6c′) with ground (Z), fourth pin (J6d) of the socket (J6) is connected in series by the path (J6d′) with the path (TMS) of the pin (PA13) of the microcontroller (U)1, the fifth pin (J6e) of the socket (J6) is connected in series by the path (J6e′) with the path (RST) of the NRST pin of the microcontroller (U1), the sixth pin (J6f) of the socket (J6) is connected in series by the path (J6f) with the path (SWO) of the pin (PB3) of the microcontroller (U1).

15. An educational device according to claim 11, characterized in that the first pin (J7a) of the socket (J7) is connected in series by the path (J7a′) to the path (TX2) of the pin PA10) of the microcontroller (U1), the second pin (J7b) of the socket (J7) is connected in series by the path (J7b′) to the track (RX2) of the pin (PA9) of the microcontroller (U1), the third pin (J7c) of the socket (J7) is connected in series by the track (J7c′) with the ground (Z).

16. An educational device according to claim 11, characterized in that the pins (J8b-J8f, J8h, J8l) of the socket (J8) are NC pins, the pin (J8a) of the socket (J8) is connected in series by the path (J8a′) to the path (BUSY) of the pin (PA1) of the microcontroller (U1), pins (J8g. J8o) of the socket (J8) are connected in series by the paths (J8g′, J8o′) to the ground (Z), pin (J8i) of the socket (J8) is connected in series by path (J8i′) to the path (U2c′) of the pin (U2c) of the power stabilizer (U2), pin (J8j) of the socket (J8) is connected in series by the path (J8j′) to the path (RX) of the pin (PA2) of the microcontroller (U1), pin (J8k) of the socket (J8) is connected in series by the path (J8k′) to the path (TX) of the pin (PA3) of the microcontroller (U1), and the pins (J8n, J8p) of the socket (J8) are connected in series by the path (J8n′, J8p′) to the loudspeaker (26).

17. An educational device according to claim 11, characterized in that the pin (J10j) of the socket (J10) is the NC pin, the pin (J10a) of the socket (J10) is connected in series by the path (J10a′) to the path (TXE) of the pin (PB4) of the microcontroller (U1), the pin (J10b) of socket (J10) is connected in series by path (J10b′) to the path (PWR) of pin (PB6) of microcontroller (U1), pin (J10c) of socket (J10) is connected in series by the path (J10c′) to the path (CD) of pin (PB8) of the microcontroller (U1), pin (J10d) of the socket (J10) is connected in series by the path (J10d′) to the path (DR) of the pin (PB9) of the microcontroller (U1), pin (J10e) of the socket (J10) is connected in series by the path (J10e′) to the path (MOSI) of the pin (PA7) of the microcontroller (U1), the pin (J10f) of the socket (J10) is connected in series by the path (J10f) to the path (SS) of the pin (PA4) of the microcontroller (U1), pins (J10g, J10n) of the socket (J10) are connected in series by the paths (J10g′, J10n′) to the ground (Z), pin (J10i) of the socket (J10) is connected in series by the path (J10i′) to the path (CE) of the pin (PB7) of the microcontroller (U1), pin (J10k) of the socket (J10) is connected in series by the path (J10k′) to the path (AM) of the pin (PB8) of the microcontroller (U1), pin (J10l) of the socket (J10) is connected in series by the path (J10l′) to the path (MISO) of the pin PA6) of the microcontroller (U1), and the pin (J10m) of the socket (J10) is connected in series by the path (J10m′) to the path (SCK) of the pin (PA5) of the U1 microcontroller.

18. An educational device according to claim 11, characterized in that the pins (VSSA, BOOT0, VSS1-VSS4) of the microcontroller (U1) are connected via paths (VSSA′, BOOT0′, VSS1′-VSS4′) to the ground (Z), and also the pin (VDDA) of the microcontroller (U1) is connected in series by a path (VDDA′) its first electric circuit with the capacitor (C5) and then with the ground (Z), the second electrical circuit with the capacitor (C6) and then with the ground (Z), the third circuit with the coil (L) and then to the path (U1v′), the pin (VBAT) of the microcontroller (U1) is connected in series by the path (VBAT′) to the path (U1v′), each pin (VDD1-VDD4) of the microcontroller (U1) is connected in series by the path (VDD1′-VDD4′) its first circuit with a capacitor (C7) and then with the ground (Z) and its second circuit to the track (U1v′), wherein the track (U1v′) is made on the PCB (19) and connects with the path (U2c′) of the pin (U2c) of the power stabilizer (U2) and with the capacitor (C8), as well as to the paths (VDDA′, VBAT′, VDD1′-VDD4′) of the pins (VDDA, VBAT, VDD1-VDD4) of the microcontroller (U1), and also each pin (PD0, PD1) of the microcontroller (U1) is connected in series by the path (PD0′, PD1′) to the capacitor (C9), and then to the ground (Z), the paths (PDO′, PD1′) are connected in parallel with the quartz resonator (X).

19. The educational device of any one of the claims 1-18, characterized in that the PCB (19) is inseparably connected to the socket (J9) for the plug of the cable to the external amplifier (23), which has two pins (J9a, J9b) connected to the paths (J9a′, J9b′) made on the PCB (19), where the pin (J9a) of the socket (J9) is connected in series by the path (J9a′) to the path (J8m′) of the pin (J8m) of the socket (J8), and the pin (J9b) of the socket (J9) is connected in series by the path (J9b′) to the ground (Z).

20. The educational device of any one of claims 1-19, characterized in that the PCB (19) is inseparably connected to the socket (J5) for the plug of the mini-USB cable, which has six pins (J5a-J5f), which are connected to the made on the PCB (19) paths (J5a′-J5f), wherein the pin (J5b) of the socket (J5) is connected in series by the path (J5b′) to the resistor (R5) and to the path (D-) of the pin (PA11) of the microcontroller (U1), pin (J5c) of the socket (J5) is connected in series by the path (J5c′) of its first electric circuit with the resistor (R5) and with the path (D+) of the pin (PA 12) of the microcontroller (U1), and of the second electric circuit in series with the resistor (R6), which is connected to the copper path (T2e′) of the emitter (T2e) of the transistor (T2) of the npn type, whose collector (T2k) is connected to the path (U2c′) of the pin (U2c) of the power regulator (U2), and the base (T2b) is connected in series by a copper path (T2b′) its first electrical circuit with a resistor (R7) and with ground (Z), wherein the paths (T2e′, T2b′) are made on the PCB (19), its second electrical circuit with a resistor (R8) and the path (ENUM) of the pin (PB4) of the microcontroller (U1) and its third circuit with the resistor (R9) and the path (J5a′) of the pin (J5a) of the socket (J5), while the pin (J5d) of the socket (J5) is connected in series by the path (J5d′) to the resistor (R10) and ground (Z), while the pins (J5e, J5f) of the socket (J5) are connected in series to each other by the paths (J5e′, J5f) and with the ground Z.

21. The educational device of any one of claims 1-20 characterized in that the 5V power source is the path (J5a′) of the pin (J5a) of the socket (J5), a battery or a charging battery.

22. The educational device of any one of claims 1-2, characterized in that the socket (J7) is equipped with a module for wireless communication.

23. The educational device of any one of claims 1-11, characterized in that the resistance of the resistor (R1) is 75Ω, the resistor (R2) is 4.7 kΩ, the resistors (R3, R4) are 3.3 kΩ, the resistor (R5) is 22Ω, the resistor (R6) is 1.5 kΩ, resistor (R7) 36 kΩ, resistor (R8) 100Ω, resistor (R9) 10 kΩ, and resistor (R10) 100 kΩ, capacity of capacitors (C1, C3, C5, C7) are 100 nF, capacitor (C2) 220 μF, capacitor (C4) 10 nF, capacitor (C6) 1 μF, capacitor (C8) 4.7 μF, and capacitor (C9) 30 pF, inductance of the coil (L) is 10 μH, and the frequency of the quartz resonator (X) is 8 MHz.

24. A method of teaching writing using the teaching device according to the claims 1-23, comprising providing the master and each slave with an SD card with stored audio data, connecting each slave and the master to a power supply and connecting them to a mains powered computer equipped with a screen, characterized in that the screen (28) displays a program containing a text editor (29), an animation window (30) and a module for handling (31) the master device (2) and each slave device (1), on which the user of the master device (2) runs a task for each user of the slave device (1), then the master device (2) communicates by radio with each slave device (1), on which the LEDs (14) of its keys turn on (3) according to the implementation of this task, and then in the event that the user of the slave device (1):
presses the non-lit key (3) of the slave device (1), the slave device (1) generates a sound from its loudspeaker (26) signalling an error, and when
presses the lit key (3) of the slave device (1), the symbol corresponding to this key (3) appears on the screen (28) in the text editor (29), and the slave device (1) generates a sound from its speaker (26) corresponding to this key (3), and when
presses all the keys (3) of the slave device (1) required for a given task, animations and graphics are displayed on the screen (28) in the animation window (30) signalling the correct execution of the task, and then the user of the master device (2) selects on the screen (28) in the handling module (31) another task.

25. The method of learning to write according to claim 24, characterized in that the connection of each slave device (1) and master device (2) to the computer (27) is made by means of wired mini-USB cables, each first plug of which is located in the socket of the computer (27), and each second plug into the receptacle (J5) of each slave (1) and master (2).

26. The method of learning to write according to claim 1. 24, characterized in that the connection of each slave device (1) and master device (2) to the computer (27) is carried out wirelessly by means of a wireless communication module embedded in the socket (J7) of each slave device (1) and master device (2).

27. The method of learning to write according to claim 24 or 25 or 26, characterized in that during the radio communication of the devices (1,2) the user of the master device (2) presses the keys (3) and the LEDs (14) of the slave (1) turn on corresponding to the pressed keys (3) of the master (2) and remain on until these keys (3) are pressed.

28. The method of learning to write according to claim 27, characterized in that while solving the task, the user of the master device (2) several times pronounces a phrase corresponding to the task selected by him, and while pressing the key (3) of the master device (2) he pronounces the letter corresponding to this key (3).

29. The method of learning to write according to claim 24 or 25 or 26, characterized in that during radio communication of the devices (1,2) the microcontroller (U1) of the master device (2) sends to the radio communication module (24) of this device appropriate electrical signals at a rate set in its subprogram and for a given time, and the LEDs (14) of the slave device (1) that turn on correspond to these electrical signals and are off until these electrical signals are sent.

30. The method of learning to write according to claim 29, characterized in that during the solution of the task, the master device (2) generates sounds in the loudspeaker (26) corresponding to the phrase constituting the solution to the given task, and then, simultaneously with electrical signals sent by the microcontroller (U1) of the master device (2), the sounds corresponding to the illuminated keys (3).

31. The method of learning to write according to any one of claims 24-30, characterized in that the sockets (J9) of each slave (1) and master (2) are connected via a cable to an external amplifier (23).
